(19) United States
(12) Patent Application Publication
(10) Pub. No.: US 2018/0096538 A1
(43) Pub. Date: Apr. 5, 2018

(54) AIR-BAG INSPECTION DEVICE AND METHOD

(71) Applicant: HONDA MOTOR CO., LTD., Tokyo (JP)

(72) Inventors: Takafumi Murakoshi, Tochigi (JP); Keiichiro Maekawa, Tochigi (JP); Masamori Umegae, Tochigi (JP); Hiroshi Miwa, Tochigi (JP); Hiroshi Saito, Tochigi (JP); Taisuke Yoshida, Tochigi (JP)

(21) Appl. No.: 15/670,276

(22) Filed: Aug. 7, 2017

(30) Foreign Application Priority Data
Sep. 30, 2016 (JP) 2016-194367

(51) Int. Cl. G07C 5/00; B60R 21/203; B62D 1/04

(52) U.S. Cl. CPC G07C 5/006; B62D 1/04; B60R 21/203

(57) ABSTRACT

After an air-bag inspection device (10) is set to a steering wheel (12), a lock release lever (48) is operated to move a lock plate (44) from a lock position to a lock release position, thereby releasing lock of a rotating plate (43). A coil spring (38) is urged to allow a left and a right clamp shafts (33) (34) to press an inner peripheral surface of the steering wheel (12). This pressing force allows the air-bag inspection device (10) to be attached to the steering wheel (12). When the start button (51) is pressed, a left sensor (14) and a right sensor (15) measure a distance to the air-bag (11). When measurement data falls within a preliminarily set predetermined range, a control device (16) determines that the air-bag (11) is properly attached to the steering wheel (12) and turns on an OK lamp (53).

### BACKGROUND OF THE INVENTION

### Field of the Invention

The present invention relates to an air-bag inspection device and method for inspecting a mounting state of an air-bag.

### Description of the Related. Art

In recent years, an air-bag for protecting a driver at the time of an accident is mounted on a steering wheel for a vehicle. Such an air-bag is mounted on the steering wheel in a state where the steering wheel is attached to the vehicle. A technique for inspecting whether or not the air-bag is properly mounted has been proposed.

In an air-bag-device-equipped steering wheel disclosed in Japanese Patent Laid-Open No. 2014-015185, a mounting pin provided on the air-bag is caused to engage with a locking spring, which is provided on the steering wheel, to thereby attach the air-bag to the steering wheel. When the mounting pin is engaged with the locking spring, the mounting pin and the locking spring are electrically connected to each other and transmit a signal to a horn switch of a vehicle.

In the air-bag-device-equipped steering wheel disclosed in Japanese Patent Laid-Open No. 2014-015185, when a signal is transmitted to the horn switch of the vehicle, the horn is actuated to confirm whether the air-bag is properly mounted on the steering wheel. However, the air-bag-device-equipped steering wheel requires an electric wire for transmitting a signal to the horn switch, and an insulating cover for preventing the mounting pin and the locking spring from being electrically connected to each other in a state where the mounting pin is not engaged with the locking spring.

### SUMMARY OF THE INVENTION

The present invention has been made in view of the above-mentioned circumstances, and an object of the present invention is to provide an air-bag inspection device and a method capable of inspecting a mounting state of an air-bag without adding any component to the air-bag.

An air-bag inspection device according to an aspect of the present invention inspects a mounting state of an air-bag mounted on a steering wheel for a vehicle, the air-bag inspection device including: a body part; a positioning part provided at the body part and configured to position the body part at a predetermined position with respect to the steering wheel; an attachment mechanism configured to detachably attach the body part positioned by the positioning part to the steering wheel; a measurement unit provided at the body part and configured to measure distances to a plurality of locations of the air-bag in a state where the body part is attached to the steering wheel; and a determination unit configured to determine whether or not the plurality of distances measured by the measurement unit falls within a predetermined range depending on each of the distances and determine the mounting state of the air-bag based on a result of the determination.

In the air-bag inspection device according to an aspect of the present invention, the body part of the air-bag inspection device is attached to the steering wheel on which the air-bag is mounted, and the measurement unit provided at the body part measures distances to a plurality of locations of the air-bag, and determines the mounting state of the air-bag based on the plurality of measured distances. Therefore, the mounting state of the air-bag can be inspected without adding any components to the air-bag.

The determination unit preferably includes a reporting unit configured to report the result of the determination of the mounting state of the air-bag by the determination unit.

According to this structure, the determination result of the mounting state of the air-bag can be recognized.

Further, the attachment mechanism preferably includes: a pair of pressing members provided at the body part and configured to be displaceable between a pressing position, where both inner surface parts facing each other on an inner surface of the steering wheel including an opening are pressed to attach the body part to the steering wheel, and a retracted position where the body part is retracted; a pressing urging unit configured to urge the pair of pressing members against the pressing position; and a pressing release member operably provided and configured to displace the pair of pressing members between the pressing position and the retracted position.

According to this structure, the pair of pressing members facing each other presses both inner surface parts facing each other of the inner surface of the steering wheel, and the body part is urged by an urging unit against the pressing position where the body part is attached to the steering wheel. This urging force allows the body part to be easily attached to the steering wheel. Further, the pressing release member is operated to displace the pair of pressing members to the retracted position, thereby allowing the body part to be set to the steering wheel, or remove the body part from the steering wheel.

The air-bag inspection device preferably further includes: a lock member configured to be displaceable between a lock position where the pressing member is locked at the retracted position and a lock release position where the lock is released; a lock urging unit configured to urge the lock member against the lock position; and a lock release member operably provided and configured to displace the lock member between the lock position and the lock release position.

According to this structure, the pair of pressing members can be locked at the retracted position, thereby allowing the body part to be easily set to the steering wheel or allowing the body part to be removed from the steering wheel.

An air-bag inspection method according to another aspect of the present invention inspects a mounting state of an air-bag mounted on a steering wheel for a vehicle, the air-bag inspection method including: positioning an inspection device at a predetermined position with respect to the steering wheel, the inspection device including a measurement unit configured to measure distances to a plurality of locations of the air-bag; attaching the inspection device positioned at the predetermined position to the steering wheel; measuring, by the measurement unit, distances to a plurality of locations of the air-bag in a state where the inspection device is attached to the steering wheel; and determining whether or not the plurality of distances measured by the measurement unit falls within a predetermined range depending on each of the distances, and determining the mounting state of the air-bag based on a result of the determination.

In the air-bag inspection method according to the present invention, the inspection device is attached to the steering wheel on which the air-bag is mounted; the measurement unit of the inspection device measures distances to a plurality of locations of the air-bag; and the mounting state of the air-bag is determined based on the plurality of measured distances. Therefore, the mounting state of the air-bag can be easily inspected without adding any components to the air-bag.

According to the present invention, it is possible to inspect a mounting state of an air-bag without adding any components to the air-bag.

### BRIEF DESCRIPTION OF THE DRAWINGS

FIG. 1 is a perspective view illustrating an air-bag inspection device and a steering wheel according to the present invention;

FIG. 2A is a top view illustrating the air-bag inspection device in a retracted state;

FIG. 2B is a top view illustrating the air-bag inspection device in a pressed state;

FIG. 3 is a top view illustrating the air-bag inspection device in a state where a lock by a lock plate is released;

FIG. 4 is a side view illustrating the air-bag inspection device and the steering wheel;

FIG. 5 is a perspective view illustrating the air-bag inspection device and the steering wheel.

FIG. 6 is a flowchart illustrating a flow of processing for inspecting a mounting state of an air-bag;

FIG. 7 is a front view illustrating the steering wheel;

FIG. 8A is a perspective view illustrating a left sensor and a mounting plate; and

FIG. 8B is a perspective view illustrating the left sensor and the mounting plate in a state there an eccentric bushing is removed.

### DETAILED DESCRIPTION OF THE PREFERRED EMBODIMENTS

Embodiments of the present invention will be described below with reference to the drawings.

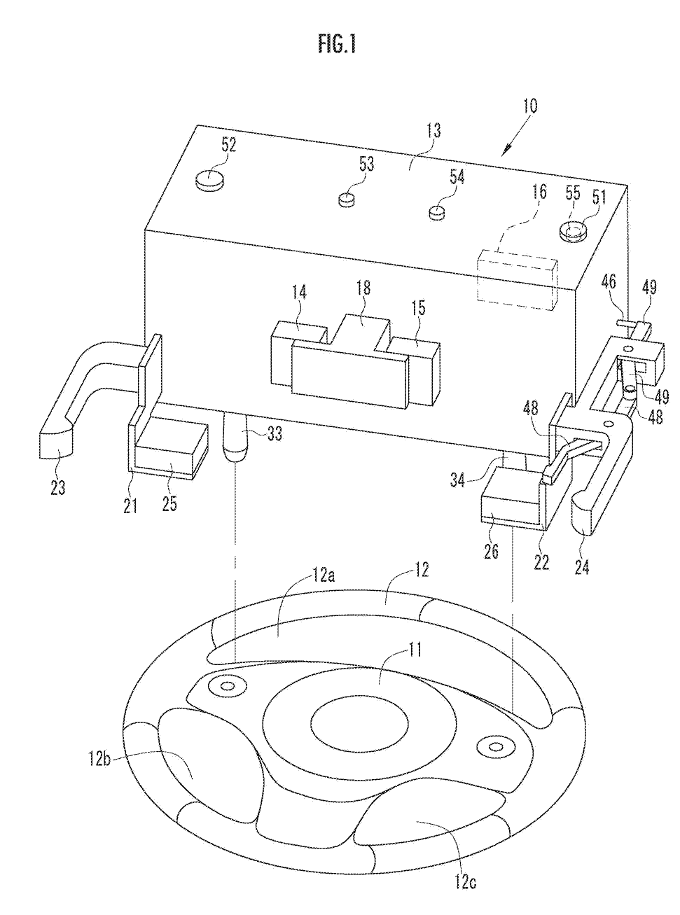

As illustrated in FIG. 1, an air-bag inspection device 10 is used to inspect whether an air-bag 11 to be inspected is properly mounted on a steering wheel 12 for a vehicle, and includes a body case 13 (body part), a left sensor 14 (measurement unit), a right sensor 15 (measurement unit), and a control device 16 (determination unit). The air-bag inspection device 10 performs inspection in a state where the steering wheel 12 is mounted on the vehicle. In this embodiment, the illustration of the vehicle is omitted.

The air-bag 11 is mounted in such a manner that the air-bag 11 is pressed into a central part of the steering wheel 12 from above. During this mounting process, for example, if a pressing force is insufficient, or if pressing forces are not appropriately applied differently to right and left parts, the air-bag 11 cannot be properly mounted on the steering wheel 12. The air-bag inspection device 10 inspects the mounting state of the air-bag 11.

The steering wheel 12 has an upper opening 12a, a left opening 12b, and a right opening 12c which are formed therein.

The left sensor 14 and the right sensor 15 measure a distance to the air-bag 11, and are attached to a front surface of the body case 13 through a mounting plate 18. The left sensor 14 and the right sensor 15 are composed of, for example, a laser displacement meter. The left sensor 14 and the right sensor 15 apply a laser to a predetermined position of the air-bag 11, and receive reflected light and perform predetermined arithmetic processing, thereby measuring a distance to the predetermined position of the air-bag 11.

On the front surface of the body case 13, a left positioning plate 21 and a right positioning plate 22 (positioning part) which have a substantially L-shape and are placed on an upper surface of the steering wheel 12 to perform positioning of the air-bag inspection device 10 in the vertical direction in FIG. 1, are attached.

On a left side surface of the left positioning plate 21, a left handle 23 for carrying the air-bag inspection device 10 is attached. On a right side surface of the right positioning plate 22, a right handle 24 for carrying the air-bag inspection device 10 is attached.

A left switch 25 is attached to the left positioning plate 21, and a right switch 26 is attached to the right positioning plate 22. Each of the switches 25 and 26 is composed of a well-known contact switch and is connected to the control device 16.

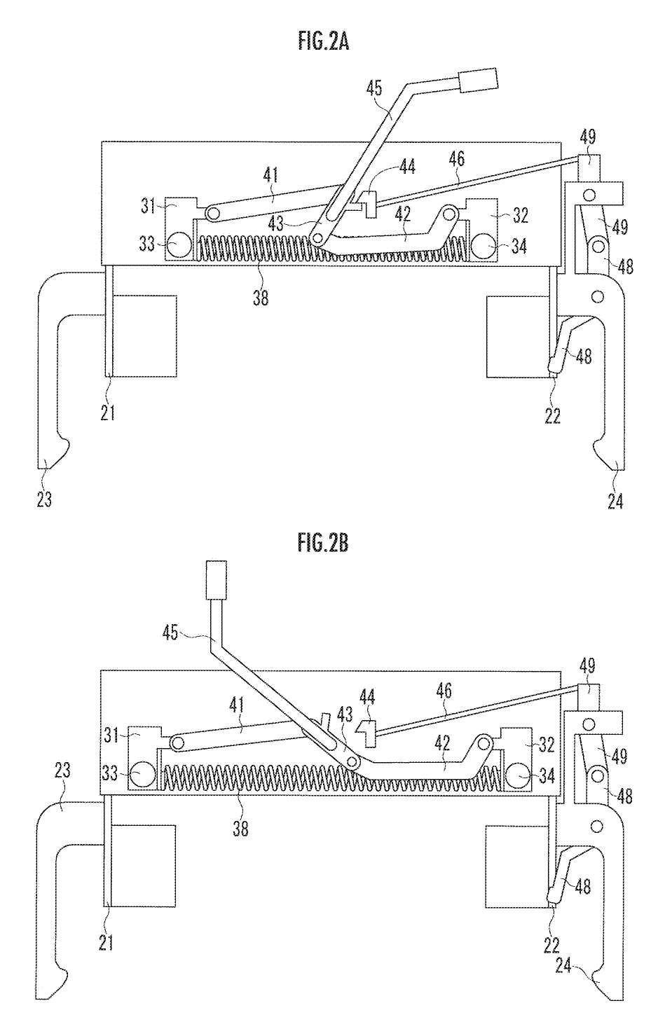

A left moving plate 31 and a right moving plate 32 (see FIG. 2) are attached to the inside of the body case 13 so as to be movable in a horizontal direction.

A left clamp shaft 33 (pressing member) which projects outward from a lower surface of the body case 13 and is inserted into a left end of the upper opening 12a of the steering wheel 12 is attached to the left moving plate 31. A right clamp shaft 34 (pressing member) which projects outward from the lower surface of the body case 13 and is inserted into a right end of the upper opening 12a is attached to the right moving plate 32. On the lower surface of the body case 13, an opening through which the left clamp shaft 33 and the right clamp shaft 34 project outward and in which the left clamp shaft 33 and the right clamp shaft 34 are movable is formed.

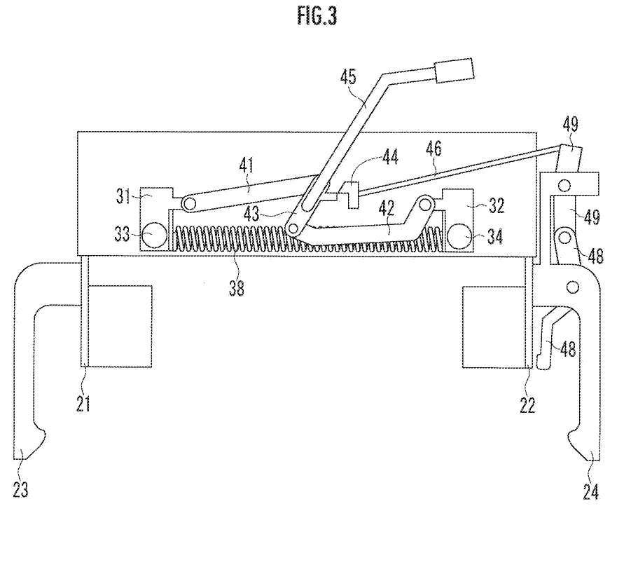

As illustrated in FIGS. 2 to 5, a coil spring 38 (pressing urging part) which urges the left moving plate 31 and the right moving plate 32 outward is disposed in the body case 13. FIGS. 2 and 3 illustrate transparent views of the body case 13, and the illustration of each of the left sensor 14, the right sensor 15, the control device 16, and the mounting plate 18 is omitted in FIGS. 2 and 3.

In the body case 13, a left coupling plate 41 coupled to the left moving plate 31, a right coupling plate 42 coupled to the right moving plate 32, a rotating plate 43 coupled to each of the left coupling plate 41 and the tight coupling plate 42, and a lock plate 44 (lock member) are disposed. The left coupling plate 41 and the right coupling plate 42 are movably provided, and the rotating plate 43 is rotatably provided. Each coupling is performed by inserting a pin formed at one end into a hole formed in the other end.

A pressing release lever 45 (pressing release member) which projects outward from a back surface of the body case 13 is attached to the rotating plate 43. The pressing release lever 45 is attached to the rotation center of the rotating plate 43. Accordingly, when the pressing release lever 45 is rotationally operated, the rotating plate 43 is rotated. On the back surface of the body case 13, an opening through which the pressing release lever 45 projects outward and in which the pressing release lever 45 can be rotated is formed. In this embodiment, the attachment mechanism for detachably attaching the body case 13 to the steering wheel 12 includes the left moving plate 31, the right moving plate 32, the left clamp shaft 33, the right clamp shaft 34, the left coupling plate 41, the right coupling plate 42, and the pressing release lever 45.

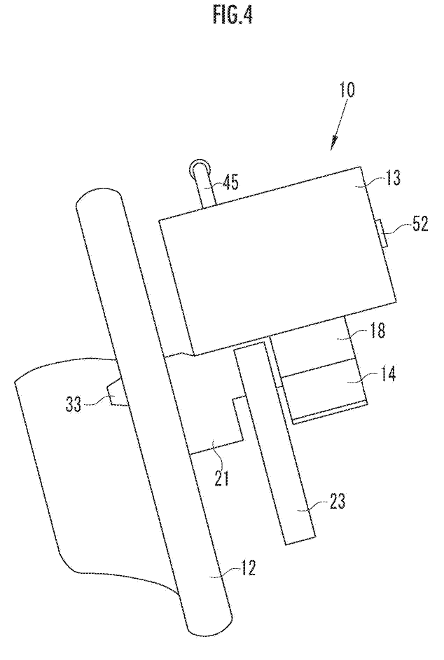

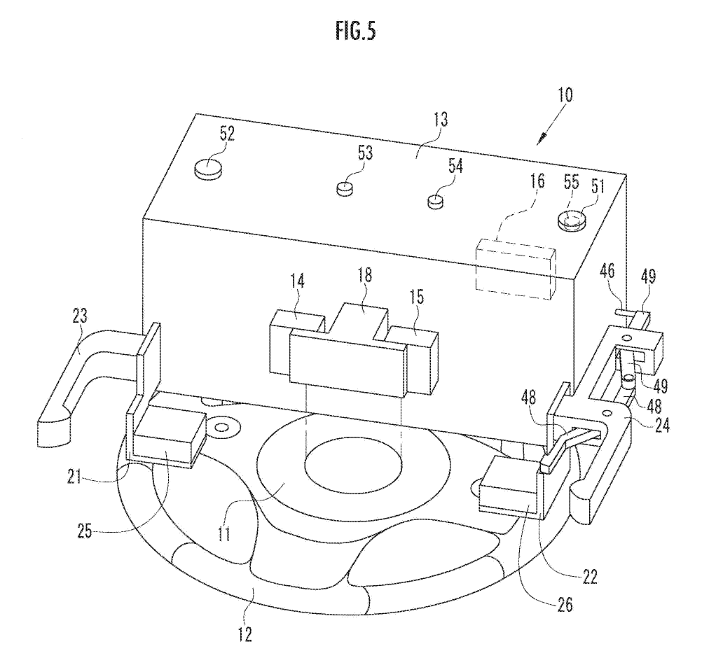

In a state where the air-bag inspection device 10 is set to the steering wheel 12, the left moving plate 31, the right moving plate 32, the left clamp shaft 33, the right clamp shaft 34, the left coupling plate 41, the right coupling plate 42, the rotating plate 43, and the pressing release lever 45 are displaced (moved or rotated) between the pressing position (see FIG. 2B) where the left clamp shaft 33 and the right clamp shaft 34 press the inner peripheral surface of the upper opening 12a of the steering wheel 12 and the retracted position (see FIG. 2A, FIG. 4, and FIG. 5).

The left moving plate 31 and the right moving plate 32 are urged against the pressing position by the coil spring 38. This urging force also urges the left clamp shaft 33, the right clamp shaft 34, the left coupling plate 41, the right coupling plate 42, the rotating plate 43, and the pressing release lever 45 against the pressing position. In this embodiment, a spring load of the coil spring 38 is set so that the pressing force for the left clamp shaft 33 and the right clamp shaft 34 to press the inner peripheral surface of the steering wheel 12 becomes a predetermined force (e.g., 5 kgf).

The lock plate 44 locks the rotating plate 43 to a retracted position. In a state where the rotating plate 43 is locked at the retracted position, the left moving plate 31, the right moving plate 32, the left clamp shaft 33, the right clamp shaft 34, the left coupling plate 41, the right coupling plate 42, and the pressing release lever 45 are also locked to the retracted position.

The lock plate 44 is provided so as to be movable between a lock position (see FIG. 2A) where the rotating plate 43 is locked at the retracted position and a lock release position (see FIG. 3) where the lock is released. A wire 46 is attached to the lock plate 44.

A lock release lever 48 and a coupling lever 49 are rotatably attached to the right handle 24. One end (a lower side in FIG. 2) of the lock release lever 48 projects from the right handle 24. The other end (an upper side in FIG. 2) of the lock release lever 48 is rotatably coupled to one end (a lower side in FIG. 2) of the coupling lever 49. The other end (an upper side in FIG. 2) of the coupling lever 49 is attached to the other end of the wire 46 whose one end is attached to the lock plate 44.

The lock release lever 48 is provided so as to be rotatable between the lock position (see FIG. 2A) where the lock plate 44 positioned at the lock position and the lock release position (see FIG. 3) where the lock plate 44 is positioned at the lock release position. The lock release lever 48 is urged against the lock position by a spring (not illustrated) during a normal operation.

When the lock release lever 48 is rotated from the lock position (see FIG. 2A) to the lock release position (see FIG. 3) against the urging force of the spring, the lock plate 44 is moved from the lock position (see FIG. 2A) to the lock release position (see FIG. 3) through the coupling lever 49 and the wire 46. Note that the lock plate 44, the wire 46, the lock release lever 48, the coupling lever 49, and the spring may be omitted.

As illustrated in FIG. 5, an upper surface of the body case 13 is provided with a transparent start button 51, a cancel button 52, an OK lamp 53 (reporting unit), and an NG lamp 54 (reporting unit). These buttons are connected to the control device 16. An LED 55 is provided in the start button 51. The LED 55 is connected to the control device 16.

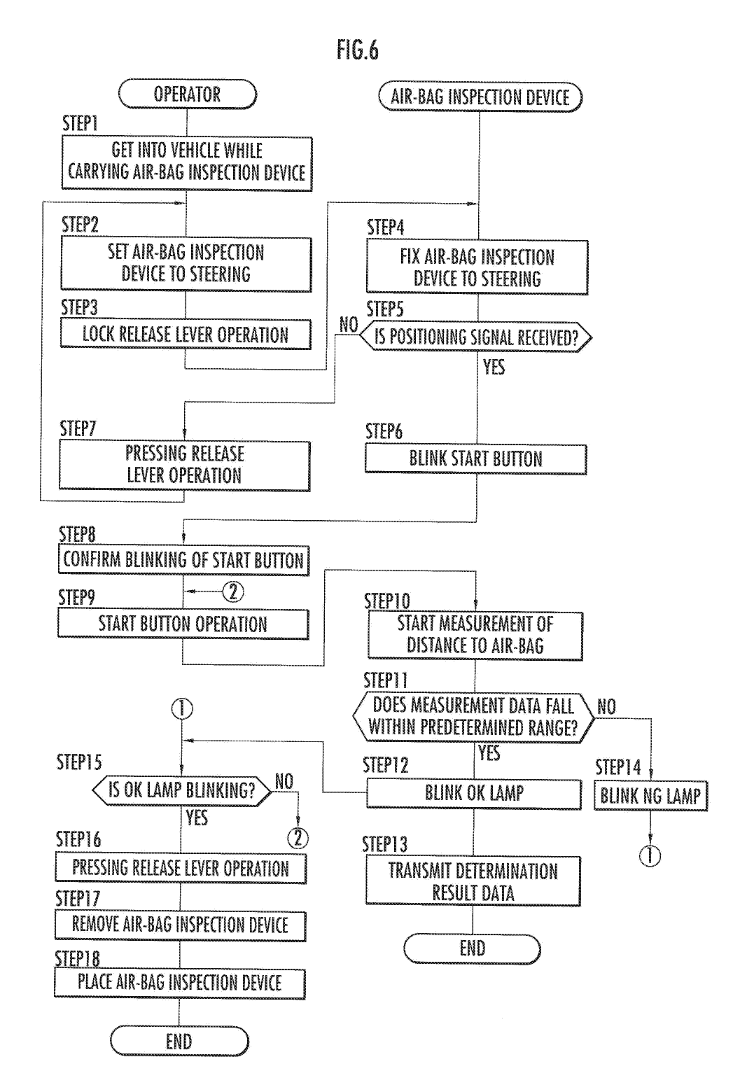

A flow of processing for inspecting the mounting state of the air-bag 11 using the air-bag inspection device 10 will be described with reference to the flowchart illustrated in FIG. 6.

First an operator carries the air-bag inspection device 10 which is placed on a holder and is in the retracted state illustrated in FIG. 2A, and gets into the vehicle on which the steering wheel 12 to be inspected is mounted (STEP1). The operator performs a work while pipping the left handle 23 and the right handle 24.

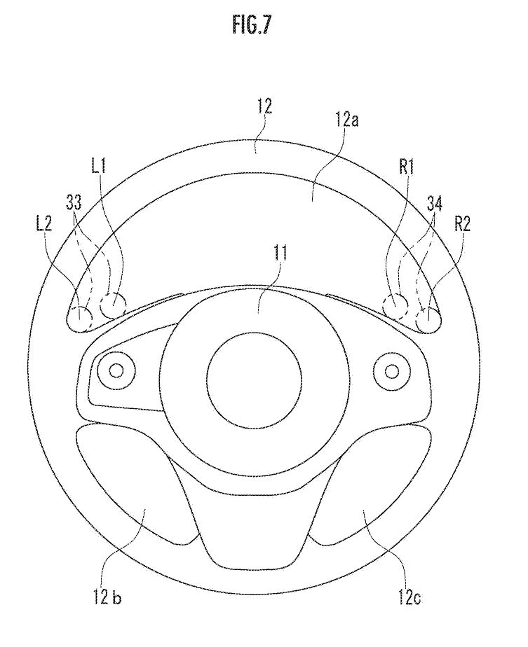

After the operator gets into the vehicle, as illustrated in FIGS. 4 and 5, the left clamp shaft 33 and the right clamp shaft 34 of the air-bag inspection device 10 (FIG. 2A) in the retracted state are inserted into the upper opening 12a of the steeling wheel 12, and the left positioning plate 21 and the right positioning plate 22 are placed on the steering wheel 12 (STEP2). In this state, the left clamp shaft 33 is located at L1 illustrated in FIG. 7, and the right clamp shaft 34 is located at R1 illustrated in FIG. 7.

When the air-bag inspection device 10 is in a pressed state (see FIG. 2B), the operator rotates the pressing release lever 45 to the retracted position (see FIG. 2A) to displace the left moving plate 31, the right moving plate 32, the left clamp shaft 33, the right clamp shaft 34, the left coupling plate 41, the right coupling plate 42, and the rotating plate 43 to the retracted position. In this state, the rotating plate 43 is locked at the retracted position by the lock plate 44 and thus brought into the state illustrated in FIG. 2A.

The operator sets the air-bag inspection device 10 to the steering wheel 12 (STEP2), and then rotates the lock release lever 48 from the lock position (see FIG. 2A) to the lock release position (see FIG. 3) (STEP3). This rotating operation allows the lock plate 44 to move from the lock position (see FIG. 2A) to the lock release position (see FIG. 3) through the coupling lever 49 and the wire 46, so that the lock of the rotating plate 43 is released as illustrated in FIG. 3.

When the lock of the rotating plate 43 is released, the coil spring 38 is urged to displace the left moving plate 31, the right moving plate 32, the left clamp shaft 33, the right clamp shaft 34, the left coupling plate 41, the right coupling plate 42, the rotating plate 43, and the pressing release lever 45 to the pressing position (see FIG. 2B). In this state, the left clamp shaft 33 is located at L2 illustrated in FIG. 7, and the right clamp shaft 34 is located at R2 illustrated in FIG. 7.

In the state illustrated in FIG. 2B, the urging force of the coil spring 38 allows the left clamp shaft 33 and the right clamp shaft 34 to press the inner peripheral surface of the steering wheel 12. This pressing force allows the air-bag inspection device 10 to be attached to the steering wheel 12 (STEP4).

When the air-bag inspection device 10 is properly set to the steering wheel 12 and the left positioning plate 21 and the right positioning plate 22 are placed on the steering wheel 12 without any gap therebetween, the left switch 25 attached to the left positioning plate 21 and the right switch 26 attached to the right positioning plate 22 are turned on to transmit a positioning signal to the control device 16.

On the other hand, when the air-bag inspection device 10 is not properly set to the steering wheel 12 and there is a gap among the left positioning plate 21, the right positioning plate 22, and the steering wheel 12, the left switch 25 and the right switch 26 are turned off and thus do not transmit the positioning signal to the control device 16.

When the control device 16 receives the positioning signals from both the left switch 25 and the right switch 26 (“YES” in STEP5), the control device blinks the LED 55 which is provided in the start button 51 (STEP6). The control device 16 turns off the LED 55 before receiving the positioning signal. Blinking of the LED 55 enables the operator to confirm that the air-bag inspection device 10 is properly set.

On the other hand, when the positioning signal is not received from the left switch 25 and the right switch 26 (“NO” in STEP5), the operator determines that the air-bag inspection device 10 is not properly set, and rotates the pressing release lever 45 to the retracted position (see FIG. 2A and FIG. 4) (STEP7). This rotating operation allows the left moving plate 31, the right moving plate 32, the left clamp shaft 33, the right clamp shaft 34, the left coupling plate 41, the right coupling plate 42, and the rotating plate 43 to be displaced to the retracted position. In this state, the rotating plate 43 is locked at the retracted position by the lock plate 44, and the air-bag inspection device 10 is maintained in the retracted state illustrated in FIG. 2A.

After STEP7, the operator performs STEP2 again.

When the air-bag inspection device 10 is properly set (“YES” in STEP5), the operator confirms blinking of the LED 55 (STEP5), and then presses the start button 51 (STEP9). When the start button 51 is pressed, the control device 16 drives the left sensor 14 and the right sensor 15 to cause the left sensor 14 and the right sensor 15 to measure the distance to the air-bag 11, and transmits measurement data to the control device 16 (STEP10). The left sensor 14 and the right sensor 15 apply laser a predetermined position of the air-bag 11, and receives reflected light and performs predetermined arithmetic processing, thereby measuring a distance to the predetermined position of the air-bag 11.

The control device 16 determines whether or not the received measurement data falls within a preliminarily set predetermined range (STEP11). When the measurement data falls within the predetermined range (“YES” in STEP11), the control device 16 determines that the air-bag 11 is properly mounted on the steering wheel 12 and turns on the OK lamp 53 (STEP12), and then transmits determination result data to a database (not illustrated) provided in a production line for producing the vehicle (STEP13). In the database, the determination result data is stored in a memory (not illustrated).

On the other hand, when the measurement data does not fall within the predetermined range (“NO” in STEP11), the control device 16 determines that the air-bag 11 is not properly mounted on the steering wheel 12, and turns on the NG lamp 54 (STEP14). The determination result data obtained when the measurement data does not fall within the predetermined range (“NO” in STEP11) is also transmitted to the database.

When the OK lamp 53 is turned on (“YES” in STEP15), the operator rotates the pressing release lever 45 to the retracted position (see FIG. 2A and FIG. 4). As a result, the left moving plate 31, the right moving plate 32, the left clamp shaft 33, the right clamp shaft 34, the left coupling plate 41, the right coupling plate 42, and the rotating plate 43 are displaced to the retracted position (see FIG. 2A) (STEP16). In this state, the rotating plate 43 is locked at the retracted position by the lock plate 44, and the air-bag inspection device 10 is maintained in the retracted state illustrated in FIG. 2A.

On the other hand, when the OK lamp 53 is not turned on and the NG lamp 54 is turned on (“NO” in STEP15), the operator performs STEP9 again. When the number of times of determination “NO” in STEP15 is a predetermined number of times (e.g., three times) or less, the operator performs STEP9. When the number of times of determination “NO” in STEP15 exceeds the predetermined number of times, it is determined that the air-bag 11 is not properly mounted on the steering wheel 12, STEP16 is performed without performing STEP9.

A lighting pattern (lighting, blinking, high-speed blinking, etc.) of the NG lamp 54 may be changed depending on the number of times of determination “NO” in STEP15. Also, when the number of times of determination “NO” in STEP15 exceeds the predetermined number of times and it is determined that the air-bag 11 is not properly mounted on the steering wheel 12, the determination result data is transmitted to the database.

The operator sets the air-bag inspection device 10 in the retracted state (STEP16) and then removes the air-bag inspection device 10 from the steering wheel 12 (STEP17). Then, the operator gets off the vehicle and places the air-bag inspection device 10 on the holder (STEP18).

Thus, in the state where the air-bag inspection device 10 is attached to the steering wheel 12, the distance to the air-bag 11 is measured. When the measurement data falls within a predetermined range, it is determined that the air-bag 11 is properly mounted on the steering wheel 12, and the OK lamp 53 is turned on. Consequently, the mounting state of the air-bag 11 can be inspected without adding any component to the steering wheel 12.

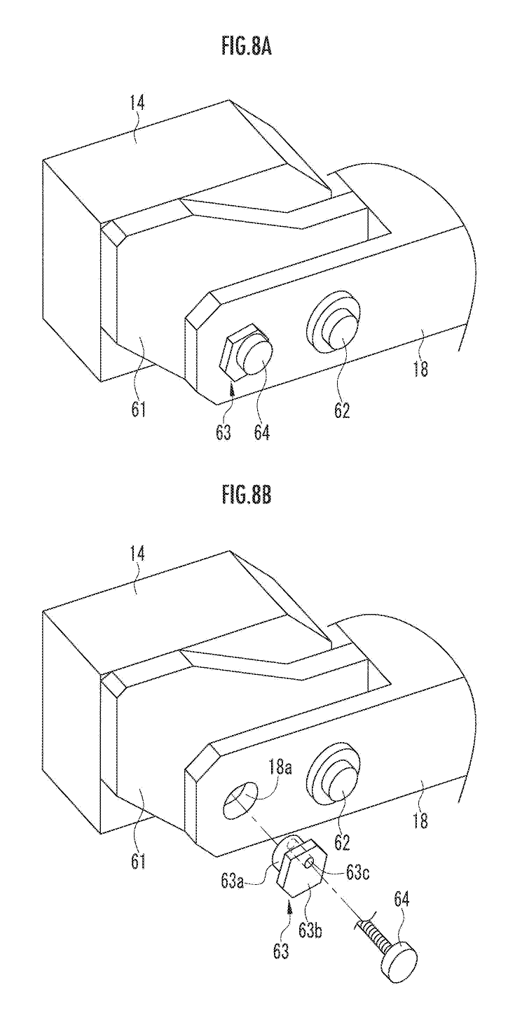

As illustrated in FIG. 8, the left sensor 14 may be rotatably attached to the mounting plate 18. As illustrated in FIG. 8A, a plate 61 is attached to the left sensor 14, and the plate 61 is rotatably attached to the mounting plate 18 centering around a mounting pin 62.

As illustrated in FIG. 8B, the mounting plate 18 has a mounting hole 18a having a long hole shape. An eccentric bushing 63 is inserted into the mounting hole 18a. The eccentric bushing 63 includes an inserting part 63a to be inserted into the mounting hole 18a, and a flange 63b. A mounting hole 63c is formed at a position eccentric to the center of the eccentric bushing.

The plate 61 is attached to the mounting plate 18 by a screw 64 through the eccentric bushing 63, and the eccentric bushing 63 is rotatably attached to the mounting plate 18. After the screw 64 is loosened, the eccentric bushing 63 is rotated, so that the screw 64 and the plate 61 are rotated around the mounting pin 62 and the left sensor 14 attached to the plate 61 is also rotated. Thus, an irradiation angle of laser light to be applied from the left sensor 14 can be adjusted. The right sensor 15 may be attached similarly.

In the above embodiments, the left clamp shaft 33 and the right clamp shaft 34 press the inner peripheral surface of the steering wheel 12, thereby attaching the air-bag inspection device 10 to the steering wheel 12. However, the attachment mechanism for attaching the body case 13 to the steering wheel 12 can be changed as appropriate. For example, the steering wheel 12 may be held by a holding part provided on the air-bag inspection device 10.

In the above embodiments, the OK lamp 53 and the NG lamp 54 report the mounting state of the air-bag 11. However, the mounting state may be reported by sound or an image, or may not be reported.

What is claimed is:

1. An air-bag inspection device that inspects a mounting state of an air-bag mounted on a steeling wheel for a vehicle, the air-bag inspection device comprising:
a body part;
a positioning part provided at the body part and configured to position the body part at a predetermined position with respect to the steeling wheel;
an attachment mechanism configured to detachably attach the body part positioned by the positioning part to the steering wheel;
a measurement unit provided at the body part and configured to measure distances to a plurality of locations of the air-bag in a state where the body part is attached to the steering wheel; and
a determination unit configured to determine whether or not the plurality of distances measured by the measurement unit falls within a predetermined range depending on each of the distances and determine the mounting state of the air-bag based on a result of the determination.

2. The air-bag inspection device according to claim 1, further comprising a reporting unit configured to report the result of the determination of the mounting state of the air-bag by the determination unit.

3. The air-bag inspection device according to claim 1, wherein
the attachment mechanism includes:
a pair of pressing members provided at the body part and configured to be displaceable between a pressing position, where both inner surface parts facing each other of an inner surface of the steering wheel including an opening are pressed to attach the body part to the steering wheel, and a retracted position where the body part is retracted;
a pressing urging unit configured to urge the pair of pressing members against the pressing position; and
a pressing release member operably provided and configured to displace the pair of pressing members between the pressing position and the retracted position.

4. The air-bag inspection device according to claim 3, further comprising:
a lock member configured to be displaceable between a lock position where the pressing member is locked at the retracted position and a lock release position where the lock is released;
a lock urging unit configured to urge the lock member against the lock position; and
a lock release member operably provided and configured to displace the lock member between the lock position and the lock release position.

5. An air-bag inspection method that inspects a mounting state of an air-bag mounted on a steering wheel for a vehicle, the air-bag inspection method comprising:
positioning an inspection device at a predetermined position with respect to the steering wheel, the inspection device including a measurement unit configured to measure distances to a plurality of locations of the air-bag;
attaching the inspection device positioned at the predetermined position to the steering wheel;
measuring, by the measurement unit, distances to a plurality of locations of the air-bag in a state where the inspection device is attached to the steering wheel; and
determining whether or not the plurality of distances measured by the measurement unit falls within a predetermined range depending on each of the distances, and determining the mounting state of the air-bag based on a result of the determination.
